(19) United States
(12) Patent Application Publication
(10) Pub. No.: US 2018/0150679 A1
(43) Pub. Date: May 31, 2018

(54) METHOD AND APPARATUS OF FINGERPRINT RECOGNITION

(71) Applicant: Samsung Electronics Co., Ltd., Suwon-si (KR)

(72) Inventors: Kyuhong KIM, Seoul (KR); Heekuk LEE, Suwon-si (KR); Hyeonho KIM, Gumi-si (KR); Haedong LEE, Daegu (KR)

(73) Assignee: Samsung Electronics Co., Ltd., Suwon-si (KR)

(21) Appl. No.: 15/804,739

(22) Filed: Nov. 6, 2017

(30) Foreign Application Priority Data
Nov. 29, 2016 (KR) 10-2016-0160806

(51) Int. Cl. G06K 9/00; G06F 3/041; G06F 17/30

(52) U.S. Cl. CPC G06K 9/00093; G06K 9/00013; G06F 3/0414; G06F 17/30256; G06K 9/00073; G06K 9/0008; G06F 17/3028; G06K 9/001

(57) ABSTRACT

A method and apparatus of fingerprint recognition are provided. A fingerprint recognition method involves obtaining an input fingerprint image in response to a fingerprint input from a user, determining pressure information relating to a pressure applied by the user to input the fingerprint image, and recognizing the user based on the obtained input fingerprint image and the pressure information.

### CROSS-REFERENCE TO RELATED APPLICATIONS

This application claims the benefit under 35 USC 119(a) of Korean Patent Application No. 10-2016-0160806 filed on Nov. 29, 2016, in the Korean Intellectual Property Office, the entire disclosure of which is incorporated herein by reference for all purposes.

### BACKGROUND

### 1. Field

The following description relates to an apparatus and a method for recognizing a fingerprint based on pressure applied by a user.

### 2. Description of Related Art

The importance of secure authentication is increasing due to the development of various mobile devices such as smartphones and wearable devices. Authentication technology based on biometrics authenticates a user by using fingerprints, irises, voices, facial features, blood vessels, or other biological characteristics. Such biological characteristics used in authentication vary from person to person and rarely change during the lifetime of a user. Further, the biological characteristics poses low risk of theft or imitation, providing high security authentication. In addition, individuals do not need to exert any efforts to carry around such characteristics at all times, unlike fobs and other external objects, and thus users are not inconvenienced by an authentication that utilizes such biological characteristics of a person.

Currently, a fingerprint recognition method is most commonly used due to convenience, security, and economical efficiency. The fingerprint recognition method may enhance the security of a user device while enabling a user to easily utilize various application services such as mobile payment.

With the recent miniaturization of portable devices, the size of the fingerprint sensing region included in a portable device may have to be reduced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a fingerprint recognition method involves obtaining an input fingerprint image in response to a fingerprint input from a user, obtaining pressure information relating to a pressure applied by the user to input the fingerprint image, and recognizing the user based on the obtained input fingerprint image and the pressure information.

The obtaining of the input fingerprint image may involve capturing the input fingerprint image corresponding to the user in response to a contact between a finger of the user and a sensor.

The recognizing of the user may involve identifying a pressure level from the pressure information, searching for a registered fingerprint corresponding to the obtained input fingerprint image from one or more registered fingerprint images corresponding to the identified pressure level, and in response to the registered fingerprint being retrieved, identifying the user as a registered user mapped to the retrieved registered fingerprint.

The searching for the registered fingerprint may involve calculating a degree of matching between the obtained input fingerprint image and each registered fingerprint image, and selecting a registered fingerprint image having the degree of matching greater than or equal to a threshold value from the one or more registered fingerprint images.

The recognizing of the user may involve, in response to a registered fingerprint corresponding to the obtained input fingerprint image not being retrieved from a registered fingerprint image corresponding to a pressure level of the pressure information, searching for a registered fingerprint corresponding to the obtained input fingerprint image from a registered fingerprint image corresponding to another pressure level, and in response to the registered fingerprint corresponding to the obtained input fingerprint image being retrieved, identifying the user as a registered user mapped to the retrieved registered fingerprint.

The searching for the registered fingerprint may involve obtaining information on matching between the input fingerprint image and the registered fingerprint image based on a deformation level corresponding to the pressure level.

The searching for the registered fingerprint may involve dividing the input fingerprint image into partial fingerprint images, calculating a degree of matching between each of the partial fingerprint images and each registered fingerprint image, and selecting a registered fingerprint image having the degree of matching greater than or equal to a threshold value.

The searching for the registered fingerprint may involve sequentially selecting a target pressure level, and searching for the registered fingerprint corresponding to the input fingerprint image from registered fingerprint images corresponding to the selected pressure level.

The searching for the registered fingerprint may involve randomly selecting a target pressure level, and searching for the registered fingerprint corresponding to the input fingerprint image from registered fingerprint images corresponding to the selected pressure level.

The obtaining of the pressure information may involve determining a pressure level of the pressure information based on a variation in a contact area during a predetermined period of time from a point in time at which the input of the fingerprint is initially generated.

The obtaining of the pressure information may involve, in response to a contact between a finger of the user and a button switch without the button switch being pressed, determining the pressure information to have a first intensity, and in response to the contact between the finger of the user and the button switch with the button switch being pressed, determining the pressure information to have a second intensity.

The obtaining of the pressure information may involve detecting, via a pressure sensor, at least one of: a region in the obtained input fingerprint image to which the pressure is applied or an intensity of the pressure.

The general aspect of the method may further involve, in response to the user being recognized, registering the input fingerprint image based on the pressure information.

The registering of the input fingerprint image may involve mapping the pressure information to the input fingerprint image and storing, in a registered fingerprint database, the input fingerprint image to which the pressure information is mapped.

The registering of the input fingerprint image may involve, in response to a degree of matching between the input fingerprint image and a registered fingerprint image being greater than or equal to a threshold score, adding the input fingerprint image to a registered fingerprint database.

The registering of the input fingerprint image may involve, in response to an overlapping region between the input fingerprint image and a registered fingerprint image being less than an overlap threshold, adding the input fingerprint image to a registered fingerprint database.

The recognizing of the user may involve extracting feature data from the input fingerprint image, excluding feature data extracted from a region in the input fingerprint image in which a pressure greater than a threshold pressure is detected, and calculating a degree of matching between the input fingerprint image and a registered fingerprint image using feature data extracted from a region in the input fingerprint image in which a pressure less than or equal to the threshold pressure is detected.

The recognizing of the user may involve identifying a pressure level from the pressure information, searching a registered fingerprint database for a registered fingerprint corresponding to the obtained input fingerprint image from a registered fingerprint image corresponding to the identified pressure level, wherein a threshold or higher number of registered fingerprint images are stored in the registered fingerprint database, and in response to the registered fingerprint not being retrieved, determining the user to be an unregistered user.

In another general aspect, a non-transitory computer-readable storage medium has stored thereon instructions that cause a computing hardware to perform the general aspect of a fingerprint recognition method described above.

In another general aspect, a fingerprint recognition apparatus includes a fingerprint sensor configured to obtain an input fingerprint image in response to a fingerprint input from a user, and a processor configured to obtain pressure information regarding a pressure applied by the user to input the fingerprint image, and recognize the user based on the obtained input fingerprint image and the pressure information.

The general aspect of the apparatus may further include a memory configured to store registered fingerprint images based on pressure levels.

The processor may be configured to identify a pressure level corresponding to the pressure applied by the user to input the fingerprint image and to recognize the user based on the identified pressure level.

Other features and aspects will be apparent from the following detailed description, the drawings, and the claims.

### BRIEF DESCRIPTION OF THE DRAWINGS

FIG. 1 is a diagram illustrating an example of a fingerprint image.

FIGS. 2 through 5 are diagrams illustrating examples of a fingerprint deformed by pressure.

FIG. 6 is a flowchart illustrating an example of a fingerprint recognition method.

FIGS. 7 through 9 are diagrams illustrating an example of a method of detecting the level of pressure applied by a user.

FIGS. 10 and 11 are diagrams illustrating an example of a fingerprint matching method based on pressure information.

FIGS. 12 and 13 are diagrams illustrating an example of a process of recognizing a fingerprint based on pressure information.

FIGS. 14 and 15 are diagrams illustrating another example of a process of recognizing a fingerprint based on pressure information.

FIG. 16 is a diagram illustrating an example of a process of recognizing a fingerprint by excluding a minutia based on pressure information.

FIG. 17 is a flowchart illustrating an example of a process of registering a fingerprint based on pressure information.

FIGS. 18 and 19 are diagrams illustrating examples of a fingerprint recognition apparatus.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of functions and constructions that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular embodiments only, and is not intended to be used to limit the disclosure. As used herein, the singular forms “a,” “an,” and “the” include the plural forms as well, unless the context clearly indicates otherwise. As used herein, the terms “comprises,” “comprising,” “includes,” and “have” and their various forms specify the presence of stated features, numbers, operations, elements, components, and/or combinations thereof, but do not preclude the presence or addition of one or more other features, numbers, operations, elements, components, and/or combinations thereof.

Terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

Unless otherwise defined, all terms, including technical and scientific terms, used herein have the same meaning as commonly understood in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

To miniaturize a portable electronic device that uses a fingerprint recognition as an authentication method, the size of a sensing region of a fingerprint sensor in the portable device may be reduced. To reduce the size of the sensing region, a technique of fingerprint registration and recognition that utilizes only a portion of a fingerprint may prove to be useful.

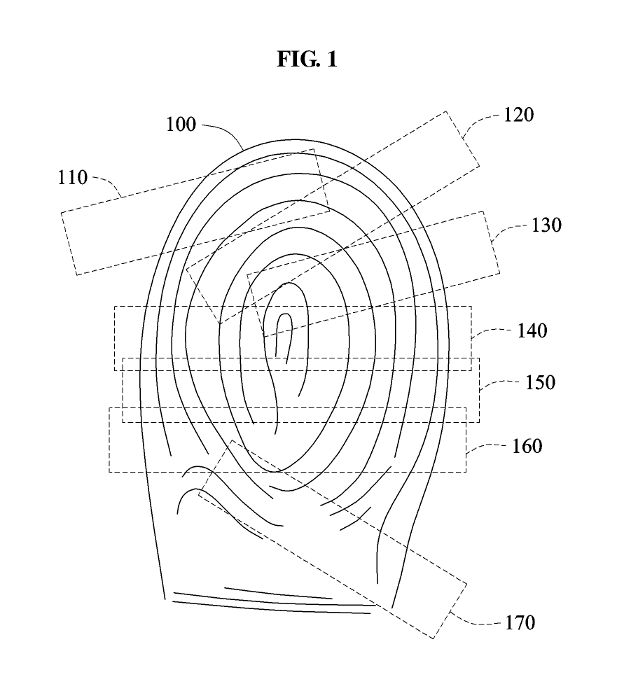

FIG. 1 illustrates an example of a fingerprint image.

Referring to FIG. 1, a fingerprint sensor (not shown) according to an embodiment detects a fingerprint 100 of a user. The fingerprint sensor detects the fingerprint 100 through a sensing region of the fingerprint sensor. The size of the sensing region of the fingerprint sensor may be smaller than the size of the entire fingerprint 100. The sensing region of the fingerprint sensor may have a rectangular shape as an example, and the rectangular region may be smaller than the size of the entire fingerprint 100. In such an example, the fingerprint sensor may detect a portion of the fingerprint 100 through the sensing region.

The fingerprint sensor generates a fingerprint image by capturing an image of a sensed fingerprint. For example, the fingerprint sensor may include a light source that emits light towards a finger of the user, placed on the sensing region, and a detector that capture an image of the finger. However, the configuration of the fingerprint sensor is not limited thereto. In the event that the size of the sensing region of the fingerprint sensor is smaller than the size of the entire fingerprint 100, the fingerprint image generated by the fingerprint sensor may correspond to a partial image that includes a portion of the fingerprint 100.

The fingerprint image may be used to register or recognize the fingerprint 100 of the user. For example, the fingerprint image may be registered during a registration process. The registered fingerprint image may be stored in a provided non-transitory memory storage. In the case that the size of the sensing region of the fingerprint sensor is smaller than the size of the fingerprint 100, a plurality of fingerprint images corresponding to a plurality of partial images of the fingerprint 100 of the user may be registered. For example, as illustrated in FIG. 1, a plurality of partial images 110 through 170 may be registered. Each of the partial images 110 through 170 covers a portion of the fingerprint 100, and the partial images 110 through 170 collectively cover substantially the fingerprint 100. In the illustrated example, the partial images 110 through 170 may overlap one another. Hereinafter, for convenience of description, a partial image of a previously registered fingerprint is referred to as a registered partial image.

Further, the fingerprint image may be recognized during a recognition process. For example, in the recognition process, the fingerprint image may be compared to a previously registered fingerprint image. Depending on whether or not the fingerprint image matches the registered fingerprint image, a result of verifying or authenticating the user or a result of identifying the user may be obtained. In the case that the size of the sensing region of the fingerprint sensor is smaller than the size of the fingerprint 100, the fingerprint image may correspond to a partial image of the fingerprint 100 of the user. Various examples of fingerprint recognition methods that compare an input partial image to a plurality of registered partial images are described below.

Although the sensing region of the fingerprint sensor illustrated in FIG. 1 has a rectangular shape, the size and shape of the sensing region of the fingerprint sensor may be variously modified. For example, the sensing region of the fingerprint sensor may have a circular shape.

According to one example, a fingerprint sensor used in the registration process and a fingerprint sensor used in the recognition process may be different from each other. For example, the fingerprint sensor with a rectangular sensing region as illustrated in FIG. 1 may be used during a registration process, and a fingerprint sensor having a circular sensing region may be used during a subsequent recognition process. However, the present disclosure is not limited thereto. In another example, the registration fingerprint sensor and the recognition fingerprint sensor may have the same shape, or may even be embodied by the same sensor.

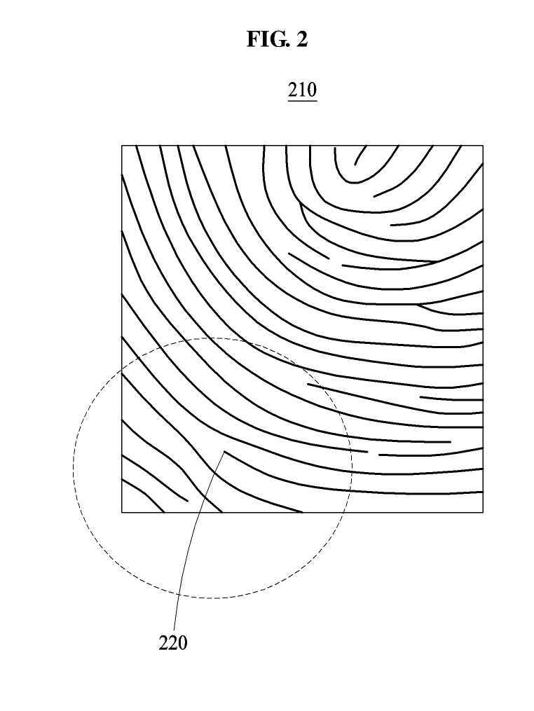

FIGS. 2 through 5 are diagrams illustrating examples of a fingerprint deformed by a pressure.

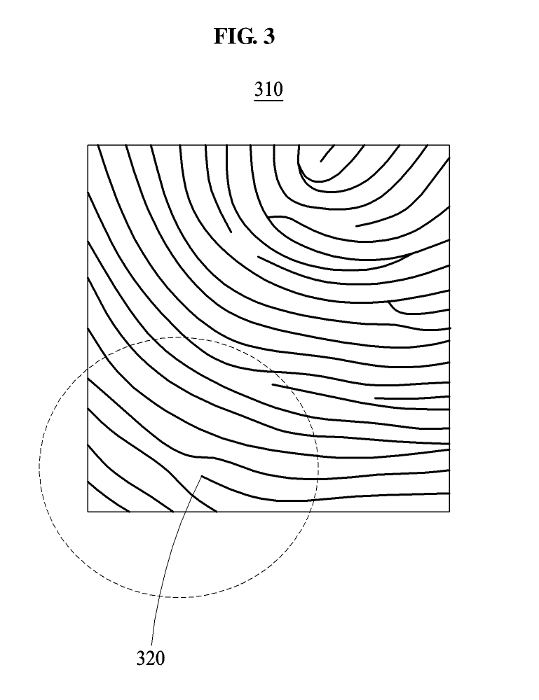

FIG. 2 illustrates a fingerprint image 210 taken without applying much pressure. That is, the fingerprint image 210 was taken by applying light pressure or substantially no pressure. FIG. 3 illustrates a fingerprint image 310 deformed by a pressure applied by the user's finger during a fingerprint process. For example, while the point 220 in the fingerprint image 210 illustrated in FIG. 2 and the point 320 in the deformed fingerprint image 310 illustrated in FIG. 3 are the same feature points, the respective locations of the points 220 and 320 in fingerprint images 210 and 310 differ from that of each other. As illustrated in FIG. 3, due to the pressure applied during the fingerprint process, a portion of a fingerprint image may become distorted. A feature point refers to a point indicating a feature of a fingerprint, such as, for example, a minutiae. The points 220 and 320 illustrated in FIGS. 2 and 3 correspond to an end point of a fingerprint ridge.

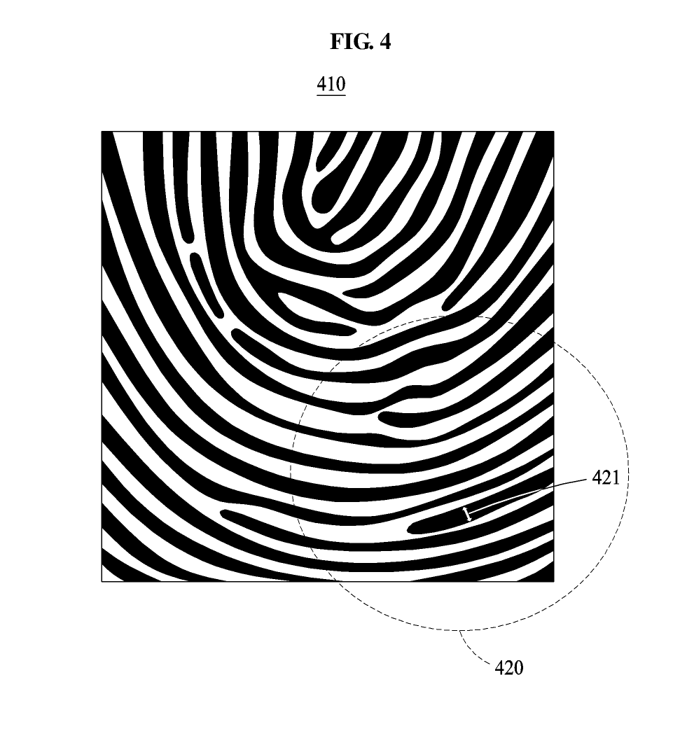

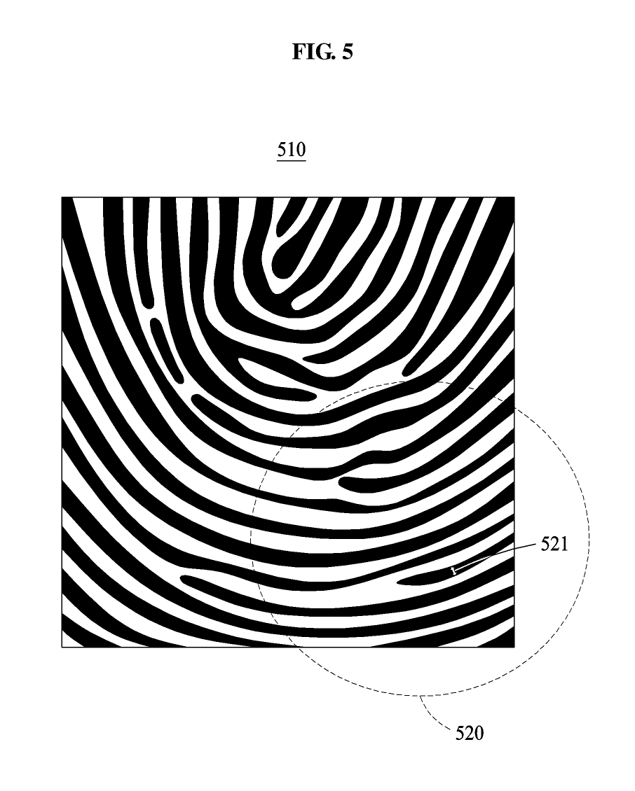

FIG. 4 illustrates a fingerprint image 410 taken without much pressure. That is, the fingerprint image 410 was obtained by applying light pressure or substantially no pressure during the fingerprint process. FIG. 5 illustrates a fingerprint image 510 deformed by the pressure applied during the fingerprint process. For example, a width 421 of a fingerprint ridge in a portion 420 of the fingerprint image 410 and a width 521 of a fingerprint ridge in a portion 520 of the fingerprint image 510 may be different from each other. As illustrated in FIG. 5, some portions of a fingerprint image may become distorted by the pressure applied during the fingerprint process.

When a user inputs a fingerprint, a contact surface may be deformed by the pressure applied by a finger of the user on the contact surface, and thus an input fingerprint image may be locally deformed. This is because, even though the user has the same fingerprint patterns, the distribution of the force applied by the finger changes each time that a fingerprint image is taken based on the placement of the finger and the degree of force applied to the contact surface. Thus, based on the degree pressure applied to a fingerprint sensor while the fingerprint is taken, the distribution characteristics of the ridges and valleys of the fingerprint may change. If no deformations were to occur between an input fingerprint image and a registered fingerprint image, the fingerprinting verification may be achieved through a simple calculation or computation. However, the user may input his or her fingerprint with different pressures based on a given situation; thus, a deformation that deviates an input fingerprint image from the registered fingerprint image may occur. Thus, according to an example of a recognition method, a fingerprint recognition apparatus may classify the pressure applied by a user when the user inputs a fingerprint into a plurality of pressure levels, thereby improving a recognition performance using the determined pressure levels along with an input fingerprint image.

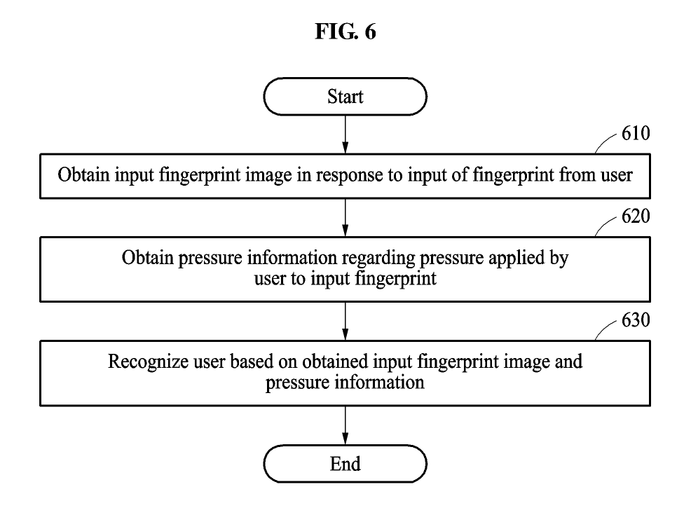

FIG. 6 is a flowchart illustrating an example of a fingerprint recognition method.

Referring to FIG. 6, in operation 610, a fingerprint recognition apparatus obtains an input fingerprint image in response to an input of a fingerprint from a user. According to one example, in response to sensing a contact between the fingerprint of the user and a sensor, the fingerprint recognition apparatus may capture the input fingerprint image corresponding to the fingerprint of the user. The input fingerprint image may be a fingerprint image corresponding to the fingerprint input from the user.

In operation 620, in response to receiving the fingerprint input, the fingerprint recognition apparatus obtains pressure information regarding the pressure applied by the user to input the fingerprint. The pressure information may include information associated with, for example, an intensity of the pressure applied by the user to input the fingerprint and an area of the sensing region to which the pressure is applied.

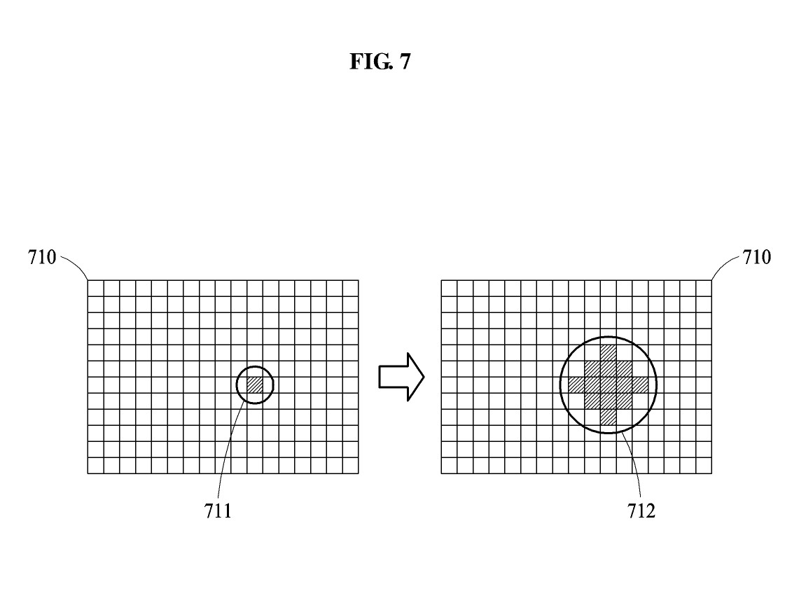

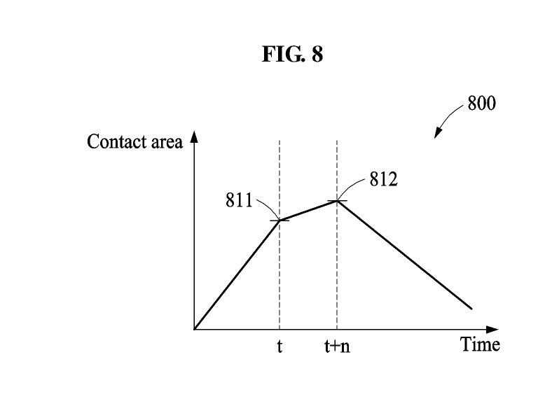

According to one example, the fingerprint recognition apparatus may determine a pressure level of the pressure information based on a variation in the contact area during a predetermined time duration from a point in time at which the input of the fingerprint is initially generated. The process of identifying the pressure level based on the variation in the contact area will be described below with reference to FIGS. 7 and 8.

According to another example, in response to detecting a contact between the finger of the user and a button switch for fingerprinting that does not result in the button switch being pressed, the fingerprint recognition apparatus may determine the pressure information to have a first intensity. In response to the button switch being pressed during the input of the fingerprint, the fingerprint recognition apparatus may determine the pressure information to have a second intensity. For example, the first intensity may indicate that a pressure intensity of the input of the fingerprint is 0, and the second intensity indicates that a pressure intensity of the input of the fingerprint is 1. For example, the pressure sensor may be a button-type pressure sensor, and the fingerprint recognition apparatus may generate the pressure information by assigning the numerical value of 1 as the pressure level of a fingerprint when the button is pressed while the fingerprint is taken and assigning the numerical value of 0 as the pressure level when the button is not pressed while the fingerprint is taken. In the event that a fingerprint sensor is disposed on a button such as an ON/OFF power button or a home button of a mobile terminal, the fingerprint recognition apparatus may determine whether a pressure of a threshold magnitude or higher is applied based on whether the button is pressed or not pressed during the fingerprint process.

In another example, by utilizing a pressure sensor, the fingerprint recognition apparatus may detect at least one of a region of the obtained input fingerprint image to which a pressure is applied or an intensity of the pressure. However, the method of obtaining the pressure information is not limited thereto. The fingerprint recognition apparatus may generate the pressure information using various methods. For example, the fingerprint recognition apparatus may detect the pressure information using a microphone and a speaker embedded in a smartphone. In another example, the fingerprint recognition apparatus may detect the pressure information using an ultrasonic sensor as a pressure sensor.

In operation 630, the fingerprint recognition apparatus recognizes a user based on the pressure information and the obtained input fingerprint image. In one example, the fingerprint recognition apparatus may identify a pressure level from the pressure information. The fingerprint recognition apparatus may have the capacity to search for a registered fingerprint that corresponds to the obtained input fingerprint image from registered fingerprint images based on the identified pressure level. In response to the registered fingerprint being retrieved, the fingerprint recognition apparatus may identify the user as a registered user mapped to the retrieved registered fingerprint.

In this example, the fingerprint recognition apparatus may search for the registered fingerprint based on the degree of matching between the input fingerprint image and the registered fingerprint image, but the recognition method is not limited thereto. The fingerprint recognition apparatus may extract an input feature from the input fingerprint image, calculate the degree of matching between the extracted input feature and a registered feature corresponding to the registered fingerprint, and detect the registered fingerprint based on the calculation. The input feature refers to a feature abstracted from the input fingerprint image, and the registered feature refers to a feature abstracted from the registered fingerprint image corresponding to the registered fingerprint.

In the event that a registered fingerprint corresponding to the obtained input fingerprint image is not retrieved from a collection of registered fingerprint images based on a pressure level of the pressure information, the fingerprint recognition apparatus may search for the registered fingerprint corresponding to the input fingerprint image from another collection of registered fingerprint images that correspond to another pressure level. The collection of registered fingerprint images may be stored in a non-transitory memory storage. In the event that a registered fingerprint corresponding to the input fingerprint image is successfully retrieved, the fingerprint recognition apparatus may identify the user as a registered user mapped to the retrieved registered fingerprint.

In another example, the fingerprint recognition apparatus may sequentially select a target pressure level, and search for the registered fingerprint corresponding to the obtained input fingerprint image from a registered fingerprint image corresponding to the selected pressure level. The target pressure level refers to a pressure level to be retrieved from a database. However, examples are not limited to the examples described in the foregoing. The fingerprint recognition apparatus may randomly select a target pressure level, and search for a registered fingerprint corresponding to the obtained input fingerprint image from the collection of registered fingerprint images corresponding to the selected pressure level.

Operations performed by the fingerprint recognition apparatus are not limited to the examples of operations described above, and a more detailed fingerprint recognition process will be described hereinafter.

FIGS. 7 through 9 are diagrams illustrating an example of a method of detecting pressure.

FIG. 7 illustrates a change in a size of a contact area on a fingerprint sensor 710 during taking a fingerprint. Although the fingerprint sensor 710 illustrated in FIG. 7 has a rectangular shape, the shape of the fingerprint sensor 710 is not limited to the illustrated example. For instance, the fingerprint sensor 710 may have a circular shape or an oval shape. Further, the fingerprint sensor 710 may be embodied by a touch panel, a touch screen, or the like.

In this example, even if a fingerprint recognition apparatus does not include a pressure sensor in addition to the touch panel, touch screen or the like, the fingerprint recognition apparatus may estimate a degree of pressure applied by a user by utilizing the fingerprint sensor 710. For example, the fingerprint sensor 710 may be embodied in a touch panel, and the fingerprint recognition apparatus may determine a pressure level using a capacitance variation of the touch panel when an object, such as a finger of a user, comes in contact with the touch panel.

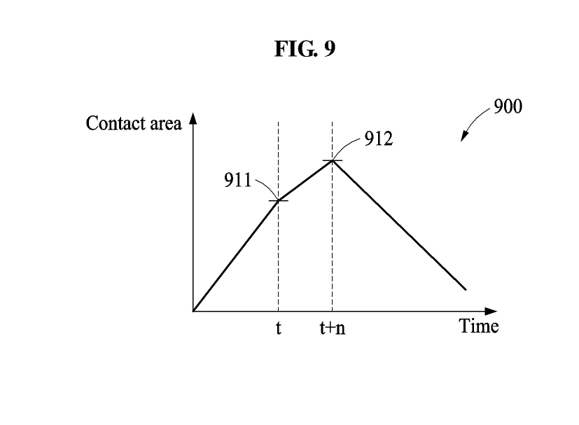

Referring to FIGS. 8 and 9, the fingerprint recognition apparatus may identify a touch input interval, for example, a time interval between 0 and t, in which an object, for example, a finger, initially comes in contact with the touch panel, and also a pressure input interval, for example, a time interval between t and t+n, in which the object applies a pressure to the touch panel. The fingerprint recognition apparatus may calculate a variation between a contact area 711 at a touch point, for example, a time point t, and a contact area 712 at a time point at which a predetermined amount of time, for example, n, elapses from the touch point, for example, at time t+n. The touch point refers to the point of time at which the touch input interval is terminated and the point of time at which an input of a fingerprint is initially generated.

The fingerprint recognition apparatus may determine a pressure intensity based on a variation in a contract area in the pressure input interval, for example, an interval between a point t and a point t+n. The fingerprint recognition apparatus may detect a variation in a contact area measured from the touch panel when a pressure is applied to a same location of a display.

The fingerprint recognition apparatus may continuously monitor a change in size of a contact area of the fingerprint sensor 710. Contact area graphs 800 and 900 illustrated in FIGS. 8 and 9 indicate a variation in a contact area over time, which may be monitored by a fingerprint recognition apparatus. The fingerprint recognition apparatus may determine a pressure level based on detecting an increase in a contact area measured at time t to a contact area measured at time t+n. For example, referring to FIG. 8, the fingerprint recognition apparatus may determine the pressure level to be relatively low based on a variation between a contact area 811 at the time point at which an input of a fingerprint is initially generated and a contact area 812 at the time point at which a preset amount of time has elapsed. In another example, referring to FIG. 9, the fingerprint recognition apparatus may determine a pressure level to be relatively high based on a variation between a contact area 911 at the time point at which an input of a fingerprint is initially generated and a contact area 912 at the time point at which a preset amount of time elapses.

According to this example, the fingerprint recognition apparatus is not limited to an apparatus that is equipped with a pressure sensor. Rather, the fingerprint recognition apparatus may measure the applied pressure using a touch panel or an ultrasonic sensor. However, the method of determining pressure is not limited thereto.

According to an example, the fingerprint recognition apparatus may store a registered fingerprint image together with the pressure information obtained when the registered fingerprint image is input by a user, and the pressure information may be visualized by visual indications such as intensity graphs or numerical values ranging from 1 through 5.

In addition, the fingerprint recognition apparatus may visualize the degree of pressure applied by a user to input the fingerprint via a graph, a color, or the like, through a user interface in order to induce the user to input the fingerprint with various pressures during the registration process of the fingerprint, and may provide feedbacks to the user. For example, the fingerprint recognition apparatus may detect pressure information on the pressure currently applied to the fingerprint sensor 710, and visualize the pressure information using a color or a graph corresponding to the pressure information through a display.

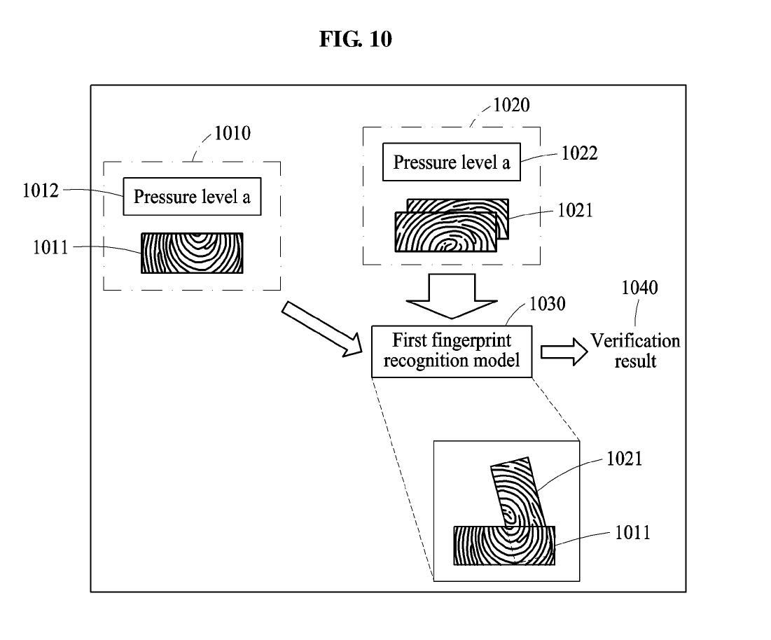

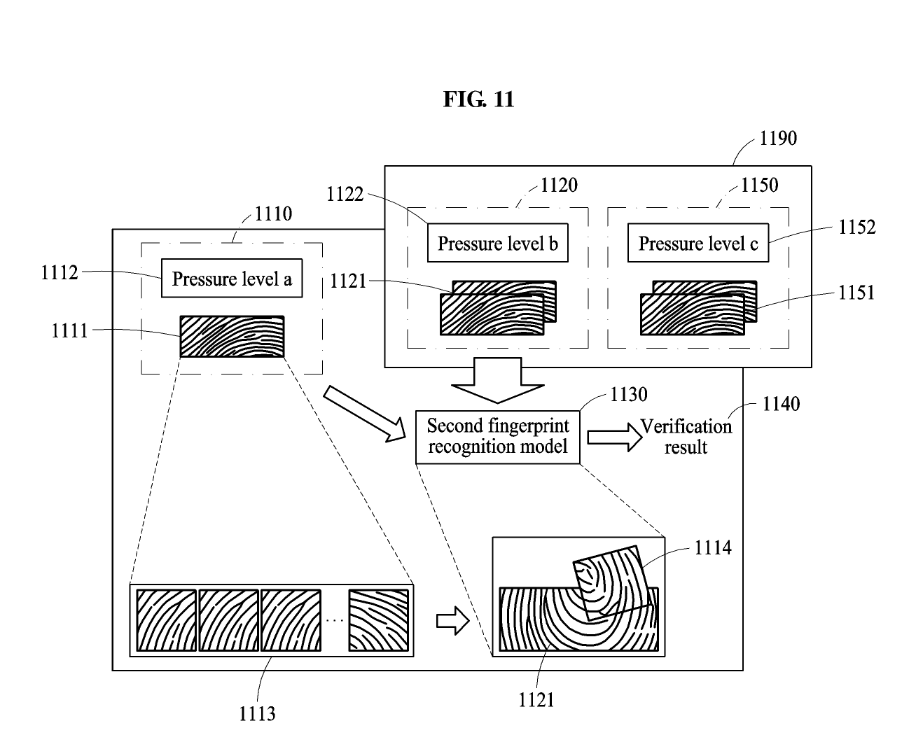

FIGS. 10 and 11 are diagrams illustrating an example of a fingerprint matching method that utilizes pressure information.

In this example, a fingerprint recognition apparatus may use a first fingerprint recognition model in order to match fingerprint images that have the same pressure level. The fingerprint recognition apparatus may also use a second fingerprint recognition model in order to match fingerprint images that have another pressure level. FIG. 10 illustrates matching performed using a first fingerprint recognition model 1030, and FIG. 11 illustrates matching performed using a second fingerprint recognition model 1130.

Referring to FIG. 10, the first fingerprint recognition model 1030 refers to a model configured to output information on a degree of matching or a degree of similarity among fingerprint images having the same pressure level. For example, using the first fingerprint recognition model 1030, the fingerprint recognition apparatus may calculate a degree of matching among the fingerprint images having the same pressure level from at least one of minutiae information, feature information, or frequency domain information of each of the fingerprint images. The fingerprint recognition apparatus may obtain input data 1010 including an input fingerprint image 1011 and pressure information 1012. However, the first fingerprint recognition model 1030 is not limited to the illustrated example. For instance, in another example, the first fingerprint recognition model 1030 may be a neural network trained to output the degree of matching among the fingerprint images having the same pressure level.

The fingerprint recognition apparatus may calculate a degree of matching between the input fingerprint image 1011 and each of registered fingerprint images 1021. In the event that the applied pressure is at the same pressure level, degrees of deformation may be identical. Thus, the fingerprint recognition apparatus may verify the input fingerprint image 1011 in association with the registered fingerprint images 1021 using the entirety of the input fingerprint image 1011. Using the first fingerprint recognition model 1030, the fingerprint recognition apparatus may determine whether fingerprints correspond to the same fingerprint without having to consider possible deformation, and thus the fingerprint recognition apparatus may recognize a fingerprint more rapidly and accurately.

For example, as illustrated in FIG. 10, the fingerprint recognition apparatus may obtain the input fingerprint image 1011, and detect a pressure level a as the pressure information 1012. The fingerprint recognition apparatus may calculate the degree of matching by comparing the input fingerprint image 1011 to the registered fingerprint images 1021 having the pressure level a as the pressure information 1022 in a database 1022. The fingerprint recognition apparatus may generate a verification result 1040 based on the calculated degree of matching. In response to determining a presence of a registered fingerprint image having a degree of matching to the input fingerprint image 1011 that is greater than or equal to a threshold value, the fingerprint recognition apparatus may determine the user to be a legitimate user.

Referring to FIG. 11, the second fingerprint recognition model 1130 refers to a model configured to output information on a degree of matching or a degree of similarity from the fingerprint images having different pressure levels. For example, using the second fingerprint recognition model 1130, the fingerprint recognition apparatus may calculate a degree of matching among the fingerprint images having different pressure levels from at least one of minutiae information, feature information, or frequency domain information of each of the fingerprint images. The second fingerprint recognition model 1130 may output a degree of matching between each of partial fingerprint images 1113 obtained by dividing an input fingerprint image 1111 and each of registered fingerprint images 1121 and registered fingerprint images 1151. In the event that the input fingerprint image 1111 is not verified through the first fingerprint recognition model 1030, the fingerprint recognition apparatus may perform the verification through the second fingerprint recognition model 1130. However, the second fingerprint recognition model 1130 is not limited to the illustrated example. For instance, the second fingerprint recognition model 1130 may be a neural network trained to output the degree of matching from the fingerprint images.

The fingerprint recognition apparatus may obtain information on the matching between the input fingerprint image 1111 and each of the registered fingerprint images 1121 and 1151 based on a deformation level corresponding to a pressure level. For example, the fingerprint recognition apparatus may divide the input fingerprint image 1111 into the partial fingerprint images 1113. The fingerprint recognition apparatus may calculate the degree of matching between each of the partial fingerprint images 1113 and each of the registered fingerprint images 1121 and 1151. Using the second fingerprint recognition model 1130, the fingerprint recognition apparatus may determine whether fingerprints correspond to the same fingerprint based on a deformation, and thus the fingerprint recognition apparatus may improve a recognition rate despite the fact that different pressures were applied during the fingerprint input process.

For example, as illustrated in FIG. 11, the fingerprint recognition apparatus may obtain input data 1110 including the input fingerprint image 1111 and a pressure level a as pressure information 1112. The fingerprint recognition apparatus may calculate the degree of matching by comparing the input fingerprint image 1111 to the registered fingerprint images 1121 having a pressure level b as pressure information 1122 and the registered fingerprint images 1151 having a pressure level c as pressure information 1152 of registered data 1120 and 1150 in a database 1190. The fingerprint recognition apparatus may divide the input fingerprint image 1111 into the partial fingerprint images 1113 by a unit of a sub-block. The fingerprint recognition apparatus may calculate the degree of matching by comparing one of the partial fingerprint images 1113, for example, a partial fingerprint image 1114, to the registered fingerprint images 1121. The fingerprint recognition apparatus may generate a verification result 1140 based on the calculated degree of matching. In response to determining a presence of a registered fingerprint image having a degree of matching to the input fingerprint image 1111 being greater than or equal to the threshold value, the fingerprint recognition apparatus may determine the user to be a legitimate user.

Although two pressure levels are illustrated in FIG. 11, the number of pressure levels is not limited to the illustrated example and a pressure level may be classified into two or more pressure levels. Using the second fingerprint recognition model 1130, the fingerprint recognition apparatus may adjust a size of a sub-block and the number of sub-blocks based on a pressure level. For example, provided that the pressure information is classified into five pressure levels, and the fingerprint recognition apparatus uses the second fingerprint recognition model 1130, the fingerprint recognition apparatus may divide the input fingerprint image 1111 into one sub-block when performing comparison based on a same pressure level, and a size of the sub-block may be the same as a size of the input fingerprint image 1111. However, in response to an increase in a difference between a pressure level of the input fingerprint image 1111 and a pressure level of a registered fingerprint image, the fingerprint recognition apparatus may increase the number of sub-blocks, and reduce a size of a sub-block.

For example, in the event that a pressure level of the input fingerprint image 1111 is 1 and a pressure level of a registered fingerprint image is 2, the fingerprint recognition apparatus may divide the input fingerprint image 1111 into two sub-blocks. In another example, a pressure level of the input fingerprint image 1111 may be 1 and a pressure level of a registered fingerprint image may be 3, and the fingerprint recognition apparatus may divide the input fingerprint image 1111 into three sub-blocks. Here, neighboring sub-blocks of the input fingerprint image 1111 may overlap one another. Since a deformation between target images to be matched to each other may increase as the number of sub-blocks increases, the fingerprint recognition apparatus may reduce a size of a unit sub-block.

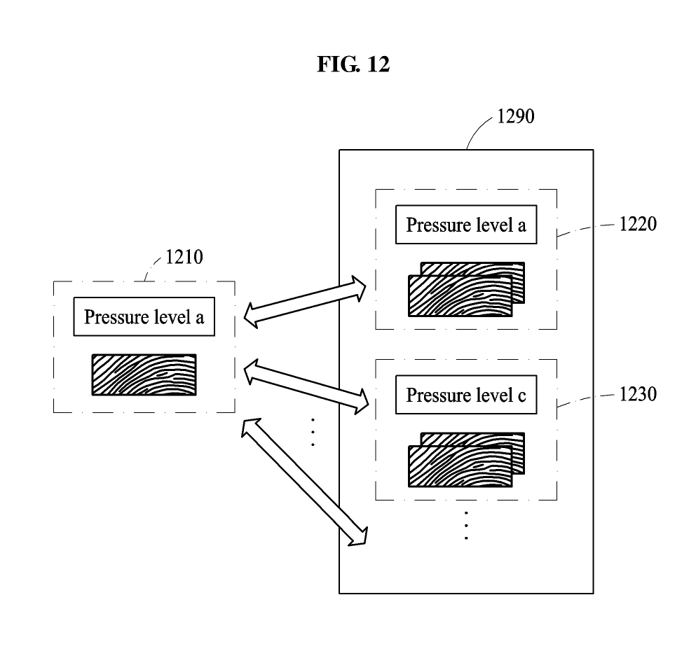

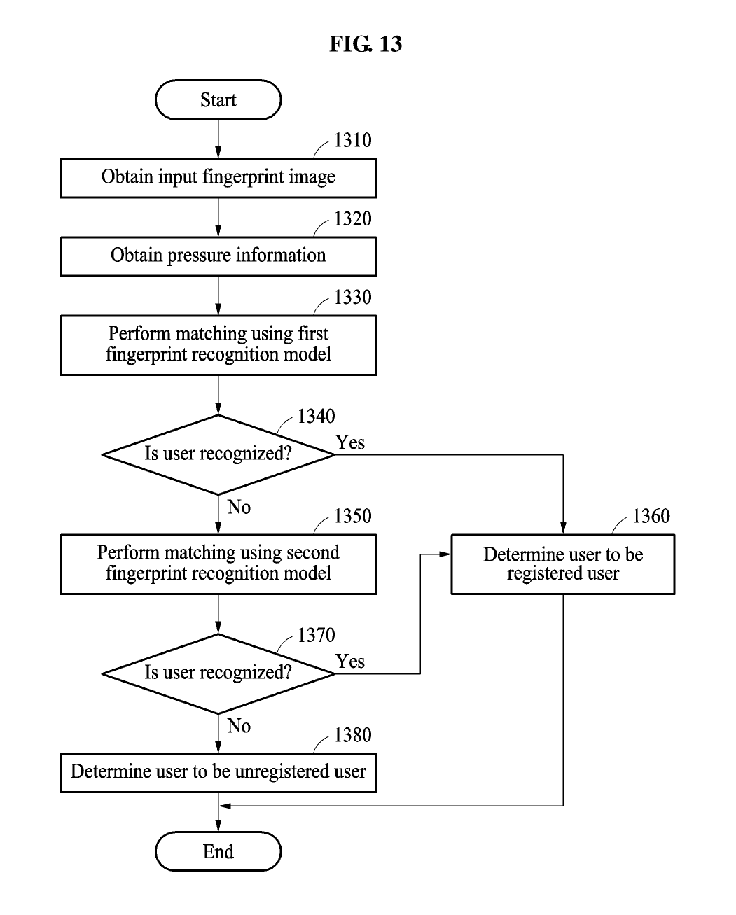

FIGS. 12 and 13 are diagrams illustrating an example of a process of recognizing a fingerprint based on pressure information.

A fingerprint recognition apparatus may store, in a database 1290, a registered fingerprint image of a registered user along with pressure information. The fingerprint recognition apparatus may store the registered fingerprint image, or compress the registered fingerprint image and store the compressed fingerprint image. In addition, the fingerprint recognition apparatus may extract only a feature of the registered fingerprint image, convert the feature, and store the feature to prevent restoration of an original fingerprint image. The pressure information relates to a value indicating an intensity, instead of storing a numerical value associated with a physical pressure. For example, the pressure information may include binary information indicating a case in which a user presses a button that includes a fingerprint sensor as 1 and a case in which the button is not pressed as 0. For another example, the fingerprint recognition apparatus may store the pressure information in a preset range, for example, natural numbers 1 through 4. The fingerprint recognition apparatus may store, in the database 1290, the registered fingerprint image of the user and the pressure information simultaneously as illustrated in FIG. 12.

Referring to FIG. 13, in operation 1310, the fingerprint recognition apparatus obtains an input fingerprint image. According to one example, the fingerprint recognition apparatus may directly use the obtained input fingerprint image for matching with a registered fingerprint image. However, the operation is not limited thereto. In another example, the fingerprint recognition apparatus may extract an input feature from the input fingerprint image and use the extracted input feature to compare the extracted input feature and a registered feature.

In operation 1320, the fingerprint recognition apparatus obtains pressure information. For a detailed description of the obtaining of the pressure information, reference may be made to the descriptions provided with reference to FIGS. 6 through 8.

In operation 1330, the fingerprint recognition apparatus performs matching using a first fingerprint recognition model. In an example, the fingerprint recognition apparatus may calculate a degree of matching between the obtained input fingerprint image and each of registered fingerprint images. For example, the fingerprint recognition apparatus may search for a registered fingerprint matching the input fingerprint image from registered fingerprints having a pressure level identical to a pressure level of the pressure information obtained in operation 1320. As illustrated in FIG. 12, the fingerprint recognition apparatus may match an input fingerprint image 1210 having a pressure level a to a registered fingerprint image 1220 having the same pressure level a.

In operation 1340, the fingerprint recognition apparatus determines whether a user is recognized. The fingerprint recognition apparatus may recognize the user based on whether or not the input fingerprint image matches the registered fingerprint image using the first fingerprint recognition model.

In operation 1360, in response to the user being recognized, the fingerprint recognition apparatus determines the user to be a registered user. For example, in response to the input fingerprint image matching one of the registered fingerprint images, the fingerprint recognition apparatus may recognize the user. The fingerprint recognition apparatus may select a registered fingerprint corresponding to a registered fingerprint image having a degree of matching being greater than or equal to a threshold value.

In operation 1350, in response to the user not being recognized, the fingerprint recognition apparatus performs matching using a second fingerprint recognition model. In an example, the fingerprint recognition apparatus may divide the input fingerprint image into partial fingerprint images. The fingerprint recognition apparatus may calculate a degree of matching between each of the partial fingerprint images and each of the registered fingerprint images. For example, as illustrated in FIG. 12, the fingerprint recognition apparatus may perform matching between the input fingerprint image 1210 having the pressure level a and a registered fingerprint image 1230 having a pressure level c.

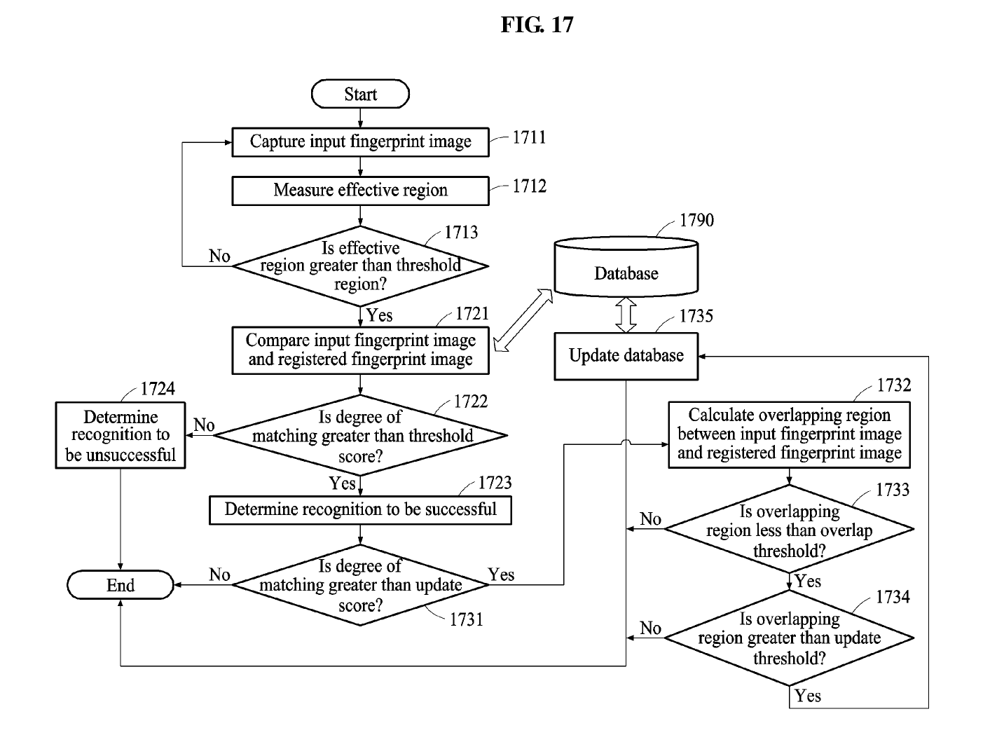

In operation 1370, the fingerprint recognition apparatus determines whether the user is recognized using the second fingerprint recognition model. The fingerprint recognition apparatus may determine whether the matching between the input fingerprint image and a registered fingerprint image that have different pressure levels from each other, which is performed using the second fingerprint recognition model, is successful. In response to the matching determined to be successful, the fingerprint recognition apparatus determines the user to be a registered user in operation 1360. The fingerprint recognition apparatus may select a registered fingerprint corresponding to a registered fingerprint image having a degree of matching being greater than or equal to the threshold value. In addition, in response to the degree of matching calculated through the second fingerprint recognition model being verified, the fingerprint recognition apparatus may apply the input fingerprint image and the corresponding pressure information to a database as illustrated in FIG. 17.

In operation 1380, in response to the user not being recognized, the fingerprint recognition apparatus determines the user to be an unregistered user. Since the user may be an unregistered user, the fingerprint recognition apparatus may restrict the user's authority to access the remaining operations of the apparatus.

In an example, using a first fingerprint recognition model having a rapid and accurate recognition rate for an input fingerprint image without deformation, and a second fingerprint recognition model having a relatively accurate recognition rate for an input fingerprint image with deformation, the fingerprint recognition apparatus may prevent a decrease in the recognition rate for the input fingerprint image with deformation and also improve a recognition speed for the input fingerprint image without deformation. In addition, using the second fingerprint recognition model only when needed for applying the pressure information, the fingerprint recognition apparatus may reduce the unnecessary amount of calculation or computation. Thus, the fingerprint recognition apparatus may maintain a rapid recognition speed and a high accuracy in recognition by recognizing a user using the first fingerprint recognition model and additionally using the second fingerprint recognition model only when the recognition fails due to a deformation of the input fingerprint image.

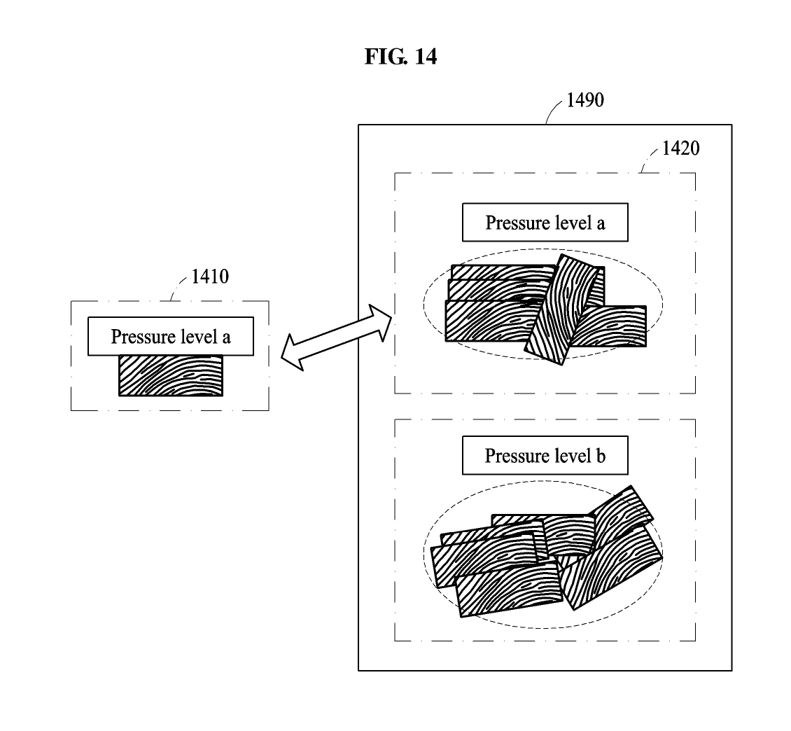

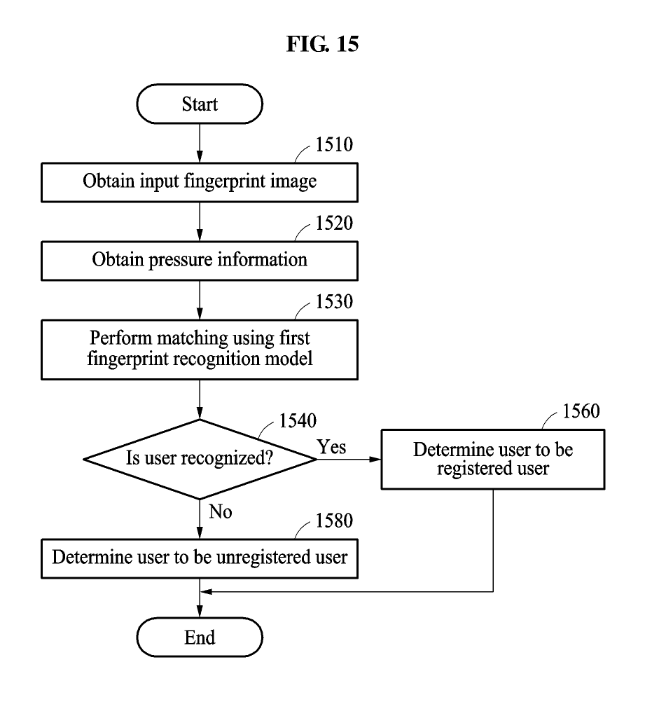

FIGS. 14 and 15 are diagrams illustrating another example of a process of recognizing a fingerprint by utilizing pressure information.

Referring to FIGS. 14 and 17, in response to an input fingerprint image 1410 obtained from a user being valid, a fingerprint recognition apparatus continuously adds a registered fingerprint image 1420 to a database 1490. The fingerprint recognition apparatus secures the registered fingerprint image 1420 sufficient to the database 1490.

In an example, the fingerprint recognition apparatus may identify a pressure level from pressure information. The fingerprint recognition apparatus searches for a registered fingerprint corresponding to the input fingerprint image 1410 from the registered fingerprint image 1420 corresponding to the identified pressure level. Here, a threshold or higher number of registered fingerprint images may be stored in the database 1490. In response to not being able to retrieve a registered fingerprint, the fingerprint recognition apparatus may determine the user to be an unregistered user. Thus, in the event that a sufficient number of registered fingerprint images corresponding to a pressure level are stored, the fingerprint recognition apparatus may calculate a degree of matching between the input fingerprint image 1410 and each of the registered fingerprint images using a first fingerprint recognition model configured to compare fingerprint images having a same pressure level.

Referring to FIGS. 14 and 15, in operation 1510, the fingerprint recognition apparatus obtains the input fingerprint image 1410. In operation 1520, the fingerprint recognition apparatus obtains pressure information. In operation 1530, the fingerprint recognition apparatus performs matching using the first fingerprint recognition model. In operation 1540, the fingerprint recognition apparatus determines whether the user is recognized.

In operation 1560, in response to the user being recognized, the fingerprint recognition apparatus determines the user to be a registered user.

In operation 1580, in response to the user not being recognized, the fingerprint recognition apparatus determines the user to be an unregistered user.

As illustrated in FIG. 14, in the database 1490, a sufficient number of registered fingerprint images corresponding to each pressure level may be stored, and thus the fingerprint recognition apparatus may recognize the user based on a degree of matching between the input fingerprint image 1410 and the registered fingerprint image 1420 only using the first fingerprint recognition model. Here, in response to a failure of the matching performed using the first fingerprint recognition model, the fingerprint recognition apparatus may terminate user recognition without using the second fingerprint recognition model. Thus, in a case that the database 1490 is fully updated, the fingerprint recognition apparatus may use only the first fingerprint recognition model and have a more rapid recognition speed and an improved recognition rate.

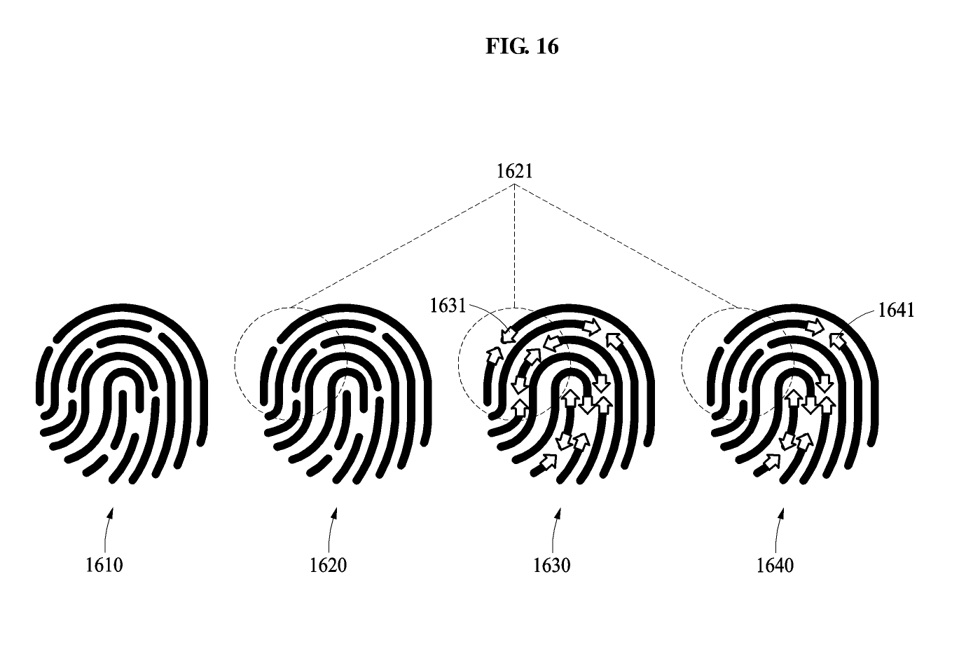

FIG. 16 is a diagram illustrating an example of a process of recognizing a fingerprint by excluding a minutia based on pressure information.

Referring to FIG. 16, a fingerprint recognition apparatus obtains an input fingerprint image in stage 1610, and detects pressure information in stage 1620. The fingerprint recognition apparatus extracts feature data from the input fingerprint image in stage 1630. The feature data indicates a feature abstracted from the input fingerprint image, and is also referred to as an input feature. In stage 1640, the fingerprint recognition apparatus excludes, from the input fingerprint image, feature data 1631 extracted from a region 1621 in the input fingerprint image from which a pressure greater than a threshold pressure is detected. The threshold pressure refers to a magnitude of a pressure set for the region 1621 of which the feature data 1631 is excluded, and the fingerprint recognition apparatus ignores the region 1621 that is insignificant to perform matching based on the threshold pressure. The fingerprint recognition apparatus calculates a degree of matching between the input fingerprint image and a registered fingerprint image using feature data 1641 extracted from a region in the input fingerprint image in which a pressure is less than or equal to the threshold pressure.

The input fingerprint image of which a pressure is greater than the threshold pressure may be deformed in a shape, and thus may be misrecognized as a fingerprint of another user. The fingerprint recognition apparatus may improve a recognition rate, or a false acceptance rate (FAR), by excluding such deformation.

FIG. 17 is a flowchart illustrating an example of a process of registering a fingerprint based on pressure information.

In an example, when an input fingerprint image is verified, a fingerprint recognition apparatus may apply the input fingerprint image to a database 1790. For example, in response a user being recognized, the fingerprint recognition apparatus may registered the input fingerprint image based on pressure information and the input fingerprint image. In response to the verification using a first fingerprint recognition model being successful, and when the input fingerprint image includes new information, for example, a non-overlapping region, the fingerprint recognition apparatus may register the input fingerprint image. In addition, in response to the verification using a second fingerprint recognition model being successful, the fingerprint recognition apparatus may register the input fingerprint image in the database 1790. The fingerprint recognition apparatus may map, to the input fingerprint image, pressure information detected when the user inputs a fingerprint of the user and store, in the database 1790, or a registered fingerprint database, the input fingerprint image to which the pressure information is mapped.

Referring to FIG. 17, in operation 1711, the fingerprint recognition apparatus captures an input fingerprint image. The fingerprint recognition apparatus may obtain the input fingerprint image corresponding to an input fingerprint through a fingerprint sensor.

In operation 1712, the fingerprint recognition apparatus measures an effective region. For example, the fingerprint recognition apparatus may measure a size of the effective region in the obtained input fingerprint image that may be used to perform matching. For example, the fingerprint recognition apparatus may determine, to be the effective region, a region from which a fingerprint ridge or a fingerprint line of the input fingerprint image is identified.

In operation 1713, the fingerprint recognition apparatus determines whether the effective region exceeds a threshold region. For example, the threshold region indicates a size defining a minimum region to be used for fingerprint matching. In response to the effective region being smaller than the threshold region, the matching may not be possible. The fingerprint recognition apparatus may repeat operation 1711 in response to the effective region being less than or equal to the threshold region.

In operation 1721, the fingerprint recognition apparatus compares the input fingerprint image and a registered fingerprint image. In an example, in response to the effective region exceeding the threshold region, the fingerprint recognition apparatus may compare the input fingerprint image and the registered fingerprint image stored in the database 1790. The fingerprint recognition apparatus may calculate a degree of matching between the input fingerprint image and the registered fingerprint image.

In operation 1722, the fingerprint recognition apparatus determines whether the degree of matching exceeds a threshold score. The threshold score refers to a score used to determine whether recognition is successful or not. In response to the degree of matching exceeding the threshold score, the matching may be determined to be successful. Conversely, in response to the degree of matching being less than or equal to the threshold score, the matching may be determined to be unsuccessful.

In operation 1723, in response to the degree of matching exceeding the threshold score, the fingerprint recognition apparatus determines the recognition to be successful.

In operation 1724, in response to the degree of matching being less than or equal to the threshold score, the fingerprint recognition apparatus determines the recognition to be unsuccessful.

In operation 1731, the fingerprint recognition apparatus determines whether the degree of matching exceeds an update score. The update score refers to a reference score indicating whether to update the input fingerprint image to the database 1790. In response to the degree of matching being less than or equal to the update score, the fingerprint recognition apparatus may terminate the fingerprint recognition.

In an example, in response to the degree of matching between the input fingerprint image and the registered fingerprint image being greater than or equal to the threshold score, the fingerprint recognition apparatus may add the input fingerprint image to the database 1790.

For example, in operation 1732, in response to the degree of matching exceeding the update score, the fingerprint recognition apparatus calculates an overlapping region between the input fingerprint image and the registered fingerprint image. The overlapping region refers to a region in which the input fingerprint image and the registered fingerprint image overlap each other.

In operation 1733, the fingerprint recognition apparatus determines whether the overlapping region is less than an overlap threshold. The overlap threshold defines a maximum overlapping region in which the input fingerprint image, which is a target to be updated, and the registered fingerprint image overlap each other. In response to the overlapping region being greater than or equal to the overlap threshold, the fingerprint recognition apparatus does not apply the input fingerprint image to the database 1790 and terminates the process. For example, in response to the overlapping region between the input fingerprint image and the registered fingerprint image being less than the overlap threshold, the fingerprint recognition apparatus adds the input fingerprint image to the database 1790.

In operation 1734, the fingerprint recognition apparatus determines whether the overlapping region exceeds an update threshold. The update threshold defines a minimum overlapping region in which the input fingerprint image, which is a target to be updated, and the registered fingerprint image overlap one another.

In operation 1735, in response to the overlapping region exceeding the update threshold, the fingerprint recognition apparatus updates the database 1790. In an example, in response to the overlapping region being less than the overlap threshold and exceeding the update threshold, the fingerprint recognition apparatus updates the input fingerprint image to the database 1790. For example, the fingerprint recognition apparatus may add the input fingerprint image to the database 1790, or replace at least one of fingerprint images registered in the database 1790 with the input fingerprint image.

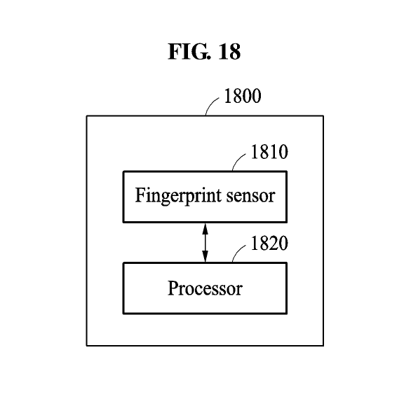

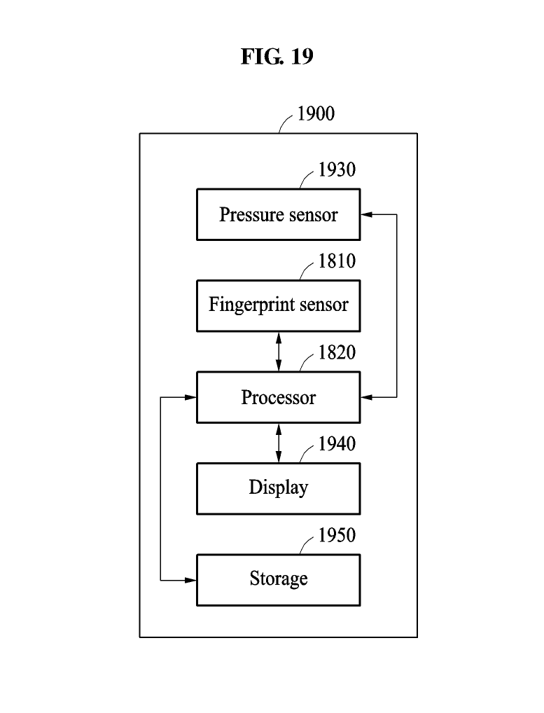

FIGS. 18 and 19 are diagrams illustrating examples of a fingerprint recognition apparatus.

Referring to FIG. 18, a fingerprint recognition apparatus 1800 includes a fingerprint sensor 1810 and a processor 1820.

The fingerprint sensor 1810 obtains an input fingerprint image in response to an input of a fingerprint from a user. The fingerprint sensor 1810 performs an operation of obtaining the input fingerprint image as described with reference to FIGS. 1 through 17. The input of the fingerprint includes all actions performed or manipulated by the user to input the fingerprint of the user. The fingerprint sensor 1810 may be embodied to perform various methods, for example, an ultrasonic method, a mutual capacitance method, and an infrared image capturing method. The fingerprint sensor 1810 may be a sensor configured to convert a fingerprint region of a certain size to an image.

The fingerprint sensor 1810 obtains a type of a curve of the fingerprint based on a minutia of the input fingerprint. For example, the fingerprint sensor 1810 may measure a curve feature, for example, a bifurcation point, a connected point, and an end point of the fingerprint. The fingerprint sensor 1810 also obtains the input fingerprint image in response to a swiping action performed by an object, for example, a finger of the user. For another example, the fingerprint recognition apparatus 1800 may guide the finger of the user to come in contact with a sensing region of a small size for convenience of the user, and the fingerprint sensor 1810 may sense the fingerprint of the finger of the user in contact with the sensing region. For still another example, in a case of the fingerprint sensor 1810 being integrated in a display, a surface of the display may be embodied as the sensing region, and the fingerprint sensor 1810 may sense the fingerprint from the finger touching the display. As described, the fingerprint sensor 1810 may be disposed on a home button, or a back or a side of the fingerprint recognition apparatus 1800, or integrated in the display.

In response to the input of the fingerprint, the processor 1820 detects pressure information on a pressure applied by the user to input of the fingerprint, and recognizes the user based on the pressure information and the obtained input fingerprint image. For example, the processor 1820 may perform operations described with reference to FIGS. 1 through 17.

Referring to FIG. 19, a fingerprint recognition apparatus 1900 further includes a pressure sensor 1930, a display 1940, and a storage 1950 in addition to the described components of the fingerprint recognition apparatus 1800.

The pressure sensor 1930 refers to a sensor configured to detect a pressure generated when a user inputs a fingerprint of the user.

The pressure sensor 1930 may include, for example, an ultrasonic sensor. In a case that a weak pressure is applied when the user inputs the fingerprint, an input fingerprint image obtained using the ultrasonic sensor may have a high pressure intensity in a central region of the input fingerprint image and a relatively low pressure intensity in an edge region of the input fingerprint image. Ultrasonic waves may not readily penetrate through an air layer, and thus a contrast of the input fingerprint image may be degraded when an object, for example, a finger of the user, is not closely attached to the ultrasonic sensor. The fingerprint recognition apparatus 1900 divides the input fingerprint image into smaller regions, measures a variance of each region, and obtains pressure information of a partial fingerprint image into which the input fingerprint image is divided.

The display 1940 visualizes information associated with fingerprint recognition, and provides the visualized information to the user. For example, the display 1940 visualizes the input fingerprint image or visualizes the pressure information detected when the user inputs the fingerprint.

The storage 1950 stores a database including a registered fingerprint image. In addition, the storage 1950 stores a first fingerprint recognition model and a second fingerprint recognition model. The storage 1950 stores a registered fingerprint image to which corresponding pressure information is mapped.

The apparatuses, units, modules, devices, and other components illustrated in FIGS. 18 and 19 that perform the operations described herein with respect to FIGS. 6, 10, 11, 12, 13, 14, 15, 16, and 17 are implemented by hardware components. Examples of hardware components include controllers, sensors, generators, drivers, and any other electronic components known to one of ordinary skill in the art. In one example, the hardware components are implemented by one or more processors or computers. A processor or computer is implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices known to one of ordinary skill in the art that is capable of responding to and executing instructions in a defined manner to achieve a desired result. In one example, a processor or computer includes, or is connected to, one or more memories storing instructions or software that are executed by the processor or computer. Hardware components implemented by a processor or computer execute instructions or software, such as an operating system (OS) and one or more software applications that run on the OS, to perform the operations described herein with respect to FIGS. 6, 10, 11, 12, 13, 14, 15, 16, and 17. The hardware components also access, manipulate, process, create, and store data in response to execution of the instructions or software. For simplicity, the singular term “processor” or “computer” may be used in the description of the examples described herein, but in other examples multiple processors or computers are used, or a processor or computer includes multiple processing elements, or multiple types of processing elements, or both. In one example, a hardware component includes multiple processors, and in another example, a hardware component includes a processor and a controller. A hardware component has any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A fingerprint recognition method comprising:
obtaining an input fingerprint image in response to a fingerprint input from a user;
obtaining pressure information relating to a pressure applied by the user to input the fingerprint image; and
recognizing the user based on the obtained input fingerprint image and the pressure information.

2. The method of claim 1, wherein the obtaining of the input fingerprint image comprises:
capturing the input fingerprint image corresponding to the user in response to a contact between a finger of the user and a sensor.

3. The method of claim 1, wherein the recognizing of the user comprises:
identifying a pressure level from the pressure information;
searching for a registered fingerprint corresponding to the obtained input fingerprint image from one or more registered fingerprint images corresponding to the identified pressure level; and
in response to the registered fingerprint being retrieved, identifying the user as a registered user mapped to the retrieved registered fingerprint.

4. The method of claim 3, wherein the searching for the registered fingerprint comprises:
calculating a degree of matching between the obtained input fingerprint image and each registered fingerprint image; and
selecting a registered fingerprint image having the degree of matching greater than or equal to a threshold value from the one or more registered fingerprint images.

5. The method of claim 1, wherein the recognizing of the user comprises:
in response to a registered fingerprint corresponding to the obtained input fingerprint image not being retrieved from a registered fingerprint image corresponding to a pressure level of the pressure information, searching for a registered fingerprint corresponding to the obtained input fingerprint image from a registered fingerprint image corresponding to another pressure level; and
in response to the registered fingerprint corresponding to the obtained input fingerprint image being retrieved, identifying the user as a registered user mapped to the retrieved registered fingerprint.

6. The method of claim 5, wherein the searching for the registered fingerprint comprises:
obtaining information on matching between the input fingerprint image and the registered fingerprint image based on a deformation level corresponding to the pressure level.

7. The method of claim 5, wherein the searching for the registered fingerprint comprises:
dividing the input fingerprint image into partial fingerprint images;
calculating a degree of matching between each of the partial fingerprint images and each registered fingerprint image; and
selecting a registered fingerprint image having the degree of matching greater than or equal to a threshold value.

8. The method of claim 5, wherein the searching for the registered fingerprint comprises:
sequentially selecting a target pressure level, and searching for the registered fingerprint corresponding to the input fingerprint image from registered fingerprint images corresponding to the selected pressure level.

9. The method of claim 5, wherein the searching for the registered fingerprint comprises:
randomly selecting a target pressure level, and searching for the registered fingerprint corresponding to the input fingerprint image from registered fingerprint images corresponding to the selected pressure level.

10. The method of claim 1, wherein the obtaining of the pressure information comprises:
determining a pressure level of the pressure information based on a variation in a contact area during a predetermined period of time from a point in time at which the input of the fingerprint is initially generated.

11. The method of claim 1, wherein the obtaining of the pressure information comprises:
in response to a contact between a finger of the user and a button switch without the button switch being pressed, determining the pressure information to have a first intensity; and
in response to the contact between the finger of the user and the button switch with the button switch being pressed, determining the pressure information to have a second intensity.

12. The method of claim 1, wherein the obtaining of the pressure information comprises:
detecting, via a pressure sensor, at least one of: a region in the obtained input fingerprint image to which the pressure is applied or an intensity of the pressure.

13. The method of claim 1, further comprising:
in response to the user being recognized, registering the input fingerprint image based on the pressure information.

14. The method of claim 13, wherein the registering of the input fingerprint image comprises:
mapping the pressure information to the input fingerprint image and storing, in a registered fingerprint database, the input fingerprint image to which the pressure information is mapped.

15. The method of claim 13, wherein the registering of the input fingerprint image comprises:
in response to a degree of matching between the input fingerprint image and a registered fingerprint image being greater than or equal to a threshold score, adding the input fingerprint image to a registered fingerprint database.

16. The method of claim 13, wherein the registering of the input fingerprint image comprises:
in response to an overlapping region between the input fingerprint image and a registered fingerprint image being less than an overlap threshold, adding the input fingerprint image to a registered fingerprint database.

17. The method of claim 1, wherein the recognizing of the user comprises:
extracting feature data from the input fingerprint image;
excluding feature data extracted from a region in the input fingerprint image in which a pressure greater than a threshold pressure is detected; and
calculating a degree of matching between the input fingerprint image and a registered fingerprint image using feature data extracted from a region in the input fingerprint image in which a pressure less than or equal to the threshold pressure is detected.

18. The method of claim 1, wherein the recognizing of the user comprises:
identifying a pressure level from the pressure information;
searching a registered fingerprint database for a registered fingerprint corresponding to the obtained input fingerprint image from a registered fingerprint image corresponding to the identified pressure level, wherein a threshold or higher number of registered fingerprint images are stored in the registered fingerprint database; and
in response to the registered fingerprint not being retrieved, determining the user to be an unregistered user.

19. A non-transitory computer-readable storage medium having stored thereon instructions that cause a computing hardware to perform the method of claim 1.

20. A fingerprint recognition apparatus comprising:
a fingerprint sensor configured to obtain an input fingerprint image in response to a fingerprint input from a user; and
a processor configured to obtain pressure information regarding a pressure applied by the user to input the fingerprint image, and recognize the user based on the obtained input fingerprint image and the pressure information.

21. The apparatus of claim 20, further comprising a memory configured to store registered fingerprint images based on pressure levels.

22. The apparatus of claim 20, wherein the processor is configured to identify a pressure level corresponding to the pressure applied by the user to input the fingerprint image and to recognize the user based on the identified pressure level.
